(19) United States
(12) Patent Application Publication
(10) Pub. No.: US 2016/0108345 A1
(43) Pub. Date: Apr. 21, 2016

(54) Detergent composition for treating fabrics with insecticides

(71) Applicant: Desayo Oyindamola Ajisegiri, Union City, NJ (US)

(72) Inventor: Desayo Oyindamola Ajisegiri, Union City, NJ (US)

(21) Appl. No.: 14/121,795

(22) Filed: Oct. 20, 2014

(51) Int. Cl. C11D 3/48; C11D 11/00; C11D 3/20; C11D 9/28

(52) U.S. Cl. CPC C11D 3/48; C11D 9/28; C11D 11/0017; C11D 3/2093

(57) ABSTRACT

A detergent composition including permethrin is disclosed that is particularly adapted to launder clothing or other personal fabrics. Laundering clothing with composition provides effective insect repellant properties to the clothing. The detergent composition is especially useful for control of mosquitoes and other insects, thereby reducing the incidence of malaria and other diseases.

### CROSS REFERENCE TO RELATED APPLICATIONS

None

### STATEMENT REGARDING FEDERALLY SPONSORED RESEARCH OR DEVELOPMENT

Not Applicable

### THE NAMES OF PARTIES TO A JOINT RESEARCH AGREEMENT

None

### INCORPORATION-BY-REFERENCE OF MATERIAL SUBMITTED ON A COMPACT DISK

None

### BACKGROUND OF THE INVENTION

Malaria is a major cause of child mortality in much of Africa. The mosquito parasite, Plasmodium falciparum, accounts for greater than 25% of childhood mortality outside the neonatal period. In parts of Africa, malaria has been ranked first by the World Bank in terms of disability-adjusted life-years lost. Drug and insecticide resistance, as well as insufficiently developed and financed health services, have hampered efforts over the past twenty years to improve the situation. As a result, the malaria burden has remained largely unchanged.

Mortality in young children due to mosquito-borne malaria poses a significant world health problem. Insecticide-treated nets and fabrics have been developed since the 1980s as a promising tool for the prevention of malaria in endemic countries. Potent and safe synthetic pyrethroids, such as, permethrin, deltamethrin, lambda-cyhalothrin, alphamethrin, and cyfluthrin, are presently used to treat bednets and curtains by simply dipping the fabric into a solution containing the insecticide and allowing the solution to dry on the fabric. Provided that the nets or fabrics are not washed more than once to twice, insecticidal activity is retained for up to twelve months.

Many studies documenting the efficacy of these nets or fabrics to reduce the number of outbreaks of malaria in endemic areas have been conducted in several countries. Recently, the World Health Organization (WHO), along with twenty other donor agencies, supported four large-scale trials in Africa to document the impact of treated bednets on child survival. The results indicated that the reduction in child mortality with the use of treated nets ranged from 16-33%. Treated nets, in combination with the use of insect repellents, have been suggested as a primary means of protection for high-risk travelers. Although little evidence is presently available to document the efficacy of treated nets or fabrics for travelers at high risk, the available evidence is so compelling that specific recommendations are often issued to all travelers exposed to situations that place them at risk for malaria.

Bednets treated with insecticides have been effective in the control of malaria in many countries. The treated bednets are an effective method of vector control in areas endemic for malaria and greatly enhance personal protection. Although there is some concern that the placement of the insecticide-treated fabric in close proximity to the skin, eyes, or mouth of the person being protected may be harmful, existing toxicology data on pyrethroids indicates that unlike other types of insecticides, these chemicals have been shown to be very safe.

The application of a residual insecticide to fabrics as a means of personal protection against vector-borne diseases has been attempted for some time. During World War II, the impregnation of bednets and combat fatigues by the Soviet, German, and U.S. armies was first tried. In the late 1970s pyrethroids were used for this purpose; their high insecticidal activity combined with low mammalian toxicity made them ideal for treating fabrics. A scientific panel convened in 1983 by WHO reviewed the first laboratory evidence and recommended the initiation of field trials to assess the potential of this technology for disease control.

Unfortunately, currently employed techniques for treating fabrics with insecticides are unable to maintain an effective level of active ingredient at the surface of the net or fabric to kill or repel mosquitoes, especially after repeated washings. In addition, currently available methods for applying insecticides to fabrics are expensive, which make their use impractical for underdeveloped countries. Further, the available techniques utilize emulsions that vary greatly between manufacturers and do not provide consistent and effective results.

Further, there is a need for fabrics treated with insecticides to repel other disease carrying vectors, such as ticks, which carry a myriad of diseases including Rocky Mountain spotted fever and Lyme disease. The Lone Star tick has recently been linked to the transmission of allergies that cause a reaction the consumption of mammalian meat, including beef, lamb, pork or potentially the consumption of any mammal. There exists a need for a fabric conditioner that will repel not only mosquitoes, but also disease carrying vectors such as ticks.

### BRIEF SUMMARY OF THE INVENTION

The invention is a novel detergent for treating fabrics that kills insects on contact and protects the user from insect bites. The composition contains a unique active ingredient, Permethrin, which is a known insecticide. Permethrin, or (3-phenoxyphenyl)methyl 3-(2,2-dichloroethenyl)-2,2 dimethylcyclopropane carboxylate, is a common synthetic, and widely used insecticide and/or insect repellant. Permethrin is a type I pyrethroid (i.e., it lacks a cyano group at the a carbon position of the alcohol moiety) with the primary target organ being the nervous system of insects which then causes muscle spasms, paralysis and death. It is a synthetic molecule similar to pyrethrum, extracted from the Chrysanthemum flower.

Permethrin is odorless when dry, and will not stain or damage clothing, fabrics, plastics, finished surfaces, or other outdoor gear. It is skin friendly and not harmful to human life. It is safe, long lasting and effective as proven the U.S Army Research Institute. The World Health Organization recommends Permethrin for the control of insects such as mosquitoes and cockroaches; it is also USDA (United States Department of Agriculture) approved and US military certified. It is used for pest control in offices, warehouses, hospitals, food processing factories, dairy operations, and other industrial/commercial buildings. Permethrin has been in use by the US and Canadian military to treat their uniform for over 30 years. It is contemplated to add Permethrin to cleaning agents (both liquid and otherwise) such as bathroom cleaners, surface cleaners etc.

### BRIEF DESCRIPTION OF THE INVENTION

A liquid solution comprising permethrin is infused into various cleaning products with the purpose to prepare detergent compositions used to treat and/or fortify fabric and other surfaces. Particular cleaning products which the permethrin/detergent compositions of the invention are combined with include but are not limited to, dry laundry detergent, laundry bar soap, and liquid laundry soap or detergent.

To formulate the liquid permethrin solution, 0.21 ounce of 36.8% liquid permethrin concentrate is added to 2 ounces of liquid detergent, which is added to 1 gallon of water. This permethrin solution is then infused into other cleaning products with the purpose to treat and/or fortify surfaces/items.

It is anticipated to combine the liquid permethrin solution of the invention with multipurpose cleaners such as floor cleaners, wall cleaners, and wood cleaners to treat various surfaces with permethrin.

Further, the liquid permethrin solution of the invention may be combined with laundry additives such as fabric softeners, starch, including spray starch, bleach, and other fabric and or laundry additives.

These products are combined with permethrin by mixing of 0.21 ounce of 36.8% permethrin concentrate per 1 gallon of the liquid cleaner or the liquid laundry soap.

### DETAILED DESCRIPTION OF THE INVENTION

A dry impregnation process has been found to produce very good results, although it is expressly understood that the invention is not to be limited to the dry impregnation process.

The novel detergent composition of the invention is prepared at room temperature under reduced pressure by dry impregnation of detergent support with a 36.8 vol % aqueous solution of permethrin in a rotary evaporator with an aspirator. Dry impregnation is a common technique used in catalysis in which a metal-containing solution is added to a catalyst support containing the same pore volume as the volume of the solution that was added. Capillary action draws the solution into the pores. Solution added in excess of the support pore volume causes the solution transport to change from a capillary action process to a diffusion process, which is much slower and wets the support in excess. Dry impregnation was particularly adopted here to avoid extra wetting of the detergent. To determine the pore volume of the detergent, Nitrogen Physisorption followed by BET calculations are carried out. A pore volume of 0.26 ml/g was established for the detergent support used herein.

After the pore volume of the detergent support being used has been determined, the following procedure is followed:
A sample of dry detergent is collected in an agitator at room temperature (Agitation is adjusted based on the sample size to eliminate the mass transfer limitation).
A volume of permethrin solution equal the pore volume of the sample of detergent collected is then added dropwise to the detergent at 1 drop/second.
The sample is left in the agitator for 15-20 minutes to allow for thorough mixing.
The detergent mixture is then placed in the oven to dry for 20 minutes at 100° C. (A rotary evaporator can also be used in this step and it is in fact the preferred technique). Reduced pressure may be used when drying the detergent composition of the invention.
A preferred ester combination would be added as per discretion at production to give the detergent a suitable smell.

To use the novel composition, the user merely has to wash his/her clothes as usual with the insecticidal composition and dry them. The cloths immediately become insect repellent and kill insects on contact for a time period before the substance wears out. The clothes or bed netting can be washed by hand using the insecticidal composition, or the composition can used in the manner of a conventional laundry detergent, in a normal washing machine.

A preferred embodiment for forming a liquid composition to which the invention is not limited comprises mixing 0.21 ounces of 36.8% permethrin solution with 2 ounces of liquid detergent and 1 gallon of water.

A preferred embodiment for forming a dry composition to which the invention is not limited, comprises mixing 0.21 ounces of permethrin 36.8% liquid concentrate to per 100 grams of dry detergent then adding the permethrin/dry detergent composition to 1 gallon of water, and drying the composition under reduced pressure.

Additives: Mix permethrin with odorant (vanilla extract) before impregnation in a 1:1 mole ratio.

To make the dry composition 0.21 ounces of liquid 36.8% permethrin concentrate is added to 100 grams of dry detergent. This mixture is then added to 1 gallon of water.

1. A laundry detergent for cleaning fabric such that the fabric immediately becomes insect repellent and kills insects on contact for a time period comprising a liquid laundry detergent and a liquid permethrin solution wherein the laundry detergent comprises 0.21 ounce of 36.8% permethrin concentrate per 1 gallon of detergent.

2. (canceled)

3. The laundry detergent for cleaning fabric of claim 1 further including products selected from the group consisting of bleach, fabric softeners, starch, and laundry additives.

4. (canceled)

5. (canceled)

6. The laundry detergent of claim 3 further including an oderant.

7. (canceled)

8. (canceled)

9. (canceled)

10. (canceled)

11. The method of making a permethrin laundry detergent composition for treating fabrics such that the fabric immediately becomes insect repellent and kills insects on contact for a time period comprising mixing 0.21 ounce of 36.8% permethrin concentrate with 2 ounces of liquid detergent and 1 gallon of water.

12. The method of making a permethrin laundry detergent composition comprising mixing 0.21 ounce of 36.8% permethrin concentrate per 1 gallon of water, to make a permethrin water solution, and impregnating a dry laundry detergent support having a pore volume of 0.26 ml/g with the permethrin water solution using capillary action, and drying the composition under reduced pressure.

13. (canceled)

14. (canceled)

15. A method of treating fabric to repel insects and kill insects on contact with the fabric comprising washing the fabric with a laundry detergent including permethrin.

16. The method of claim 15 including the steps of mixing 0.21 ounce of 36.8% permethrin concentrate with 2 ounces of liquid laundry detergent and 1 gallon of water.

17. The method of claim 12 including the step of determining the pore volume using nitrogen physisorption followed by BET calculations.
